(19) United States
(12) Patent Application Publication
(10) Pub. No.: US 2025/0237510 A1
(43) Pub. Date: Jul. 24, 2025

(54) POSITION ESTIMATION APPARATUS AND VEHICLE CONTROL SYSTEM

(71) Applicant: Honda Motor Co., Ltd., Tokyo (JP)

(72) Inventors: Naoki Mori, Tokyo (JP); Kazuma Ohara, Tokyo (JP)

(21) Appl. No.: 19/017,728

(22) Filed: Jan. 12, 2025

(30) Foreign Application Priority Data
Jan. 19, 2024 (JP) 2024-006849

(51) Int. Cl. G01C 21/30; G06V 20/58

(52) U.S. Cl. CPC G01C 21/30; G06V 20/58

(57) ABSTRACT

A position estimation apparatus estimates a position of a vehicle based on a first feature point of an object included in a camera image and a second feature point of the object included in map information. The apparatus includes a memory storing type information indicating a type of the object corresponding to the second feature point together with the map information, and a microprocessor performing: extracting the first feature point from the camera image, recognizing the type of the object corresponding to the first feature point based on the camera image, searching for the second feature point corresponding the first feature point from the map information based on the first feature point, the type of the object corresponding to the first feature point, and the type information, and estimating the position of the vehicle based on the first feature point and the second feature point.

### CROSS-REFERENCE TO RELATED APPLICATION

This application is based upon and claims the benefit of priority from Japanese Patent Application No. 2024-006849 filed on Jan. 19, 2024, the content of which is incorporated herein by reference.

### BACKGROUND

### Technical Field

The present invention relates to a position estimation apparatus and vehicle control system configured to estimate a position of a subject vehicle.

### Related Art

In recent years, a vehicle control system that leads to improvement of traffic safety and contributes to development of a sustainable transportation system is desired. As this type of device, there has been conventionally known a device configured to detect a distance to an object present around a moving body, match detection data with map data, and estimate a self-position of the moving body (for example, see JP 2021-176052 A). In the device described in JP 2021-176052 A, a reference position for starting the estimation of the self-position is reset when a deviation amount of the estimated self-position becomes equal to or more than a predetermined threshold, so that a decrease in estimation accuracy that may occur when the surrounding environment of the moving body is different from the map data is suppressed.

However, in a method of matching the detection data with the map data as in the device described in JP 2021-176052 A, when an object having a partially similar shape such as a division line or a crosswalk of a road exists around the moving body, there is a possibility that erroneous matching between the detection data and the map data occurs and the estimation accuracy of the self-position decreases.

### SUMMARY

An aspect of the present invention is a position estimation apparatus configured to estimate a position of a vehicle based on a first feature point of an object around the vehicle included in a detection data of an in-vehicle detection unit detecting a situation around the vehicle and a second feature point of the object included in map information, the position estimation apparatus including: a microprocessor and a memory coupled to the microprocessor. The memory is configured to store type information indicating a type of the object corresponding to the second feature point together with the map information. The microprocessor is configured to perform: extracting the first feature point from the detection data of the in-vehicle detection unit; recognizing the type of the object corresponding to the first feature point, based on the detection data of the in-vehicle detection unit; searching for the second feature point corresponding the first feature point from the map information based on the first feature point, the type of the object corresponding to the first feature point, and the type information stored in the memory; and estimating the position of the vehicle based on the first feature point and the second feature point.

### BRIEF DESCRIPTION OF DRAWINGS

The objects, features, and advantages of the present invention will become clearer from the following description of embodiments in relation to the attached drawings, in which:

FIG. 1 is a block diagram schematically illustrating an overall configuration of a vehicle control system according to an embodiment of the present invention;

FIG. 2 is a diagram for explaining association of feature points;

FIG. 3A is a diagram illustrating an example of a camera image acquired by an in-vehicle camera while a vehicle is traveling;

FIG. 3B is a diagram illustrating an example of an environmental map corresponding to an imaging range of the camera image in FIG. 3A;

FIG. 4A is a diagram illustrating an example of erroneous matching;

FIG. 4B is a diagram illustrating another example of erroneous matching;

FIG. 5 is a block diagram illustrating a configuration of main parts of the position estimation apparatus according to the embodiment of the present invention;

FIG. 6 is a diagram schematically illustrating the camera image divided into regions for each type of object;

FIG. 7 is a diagram for explaining an estimation error of a position and posture of the subject vehicle;

FIG. 8A is a diagram for explaining a constraint condition added to a bundle adjustment;

FIG. 8B is a diagram for explaining the constraint condition added to the bundle adjustment; and

FIG. 9 is a flowchart illustrating an example of processing to be performed by the controller in FIG. 5.

### DETAILED DESCRIPTION

An embodiment of the invention will be described below with reference to the drawings. A position estimation apparatus according to an embodiment of the present invention is applicable to a vehicle having a self-driving capability, that is, a self-driving vehicle. Note that a vehicle to which the position estimation apparatus according to the present embodiment is applied may be referred to as a subject vehicle to be distinguished from other vehicles. The subject vehicle may be any of an engine vehicle having an internal combustion engine (engine) as a traveling drive source, an electric vehicle having a traveling motor as the traveling drive source, and a hybrid vehicle having an engine and a traveling motor as the traveling drive source. The subject vehicle can travel not only in a self-drive mode in which driving operation by a driver is unnecessary, but also in a manual drive mode with driving operation by the driver.

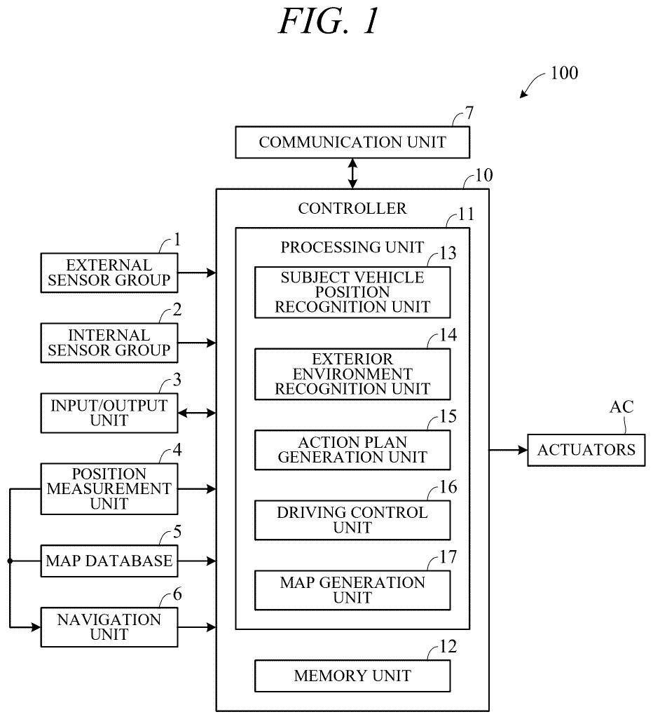

First, a schematic configuration of the subject vehicle related to self-driving will be described. FIG. 1 is a block diagram schematically illustrating an overall configuration of a vehicle control system 100 of the subject vehicle including the position estimation apparatus according to the present embodiment. As illustrated in FIG. 1, the vehicle control system 100 mainly includes a controller 10, an external sensor group 1, an internal sensor group 2, an input/output device 3, a position measurement unit 4, a map database 5, a navigation unit 6, a communication unit 7, and traveling actuators AC each communicably connected to the controller 10.

The external sensor group 1 is a generic term for a plurality of sensors (external sensors) that detect an external situation which is peripheral information of the subject vehicle. For example, the external sensor group 1 includes a LiDAR that measures reflected light with respect to irradiation light in all directions of the subject vehicle and measures the distance from the subject vehicle to surrounding obstacles, a radar that detects other vehicles, obstacles, and the like around the subject vehicle by irradiating electromagnetic waves and detecting reflected waves, and a camera that is installed in the subject vehicle, has an imaging element (image sensor) such as a charge coupled device (CCD) or a complementary metal oxide semiconductor (CMOS), and captures images of the surrounding (front, rear, and side) of the subject vehicle.

The internal sensor group 2 is a generic term for a plurality of sensors (internal sensors) that detect a traveling state of the subject vehicle. For example, the internal sensor group 2 includes an inertial measurement unit (IMU) or the like that detects rotational angular velocity around three axes in a vertical direction at the center of gravity of the subject vehicle, a front-rear direction (advancing direction) of the subject vehicle, and a lateral direction (vehicle-width direction) of the subject vehicle, and accelerations in the directions of three axes. The internal sensor group 2 also includes a sensor that detects a driver's driving operation in the manual drive mode, for example, an operation of an accelerator pedal, an operation of a brake pedal, an operation of a steering wheel, or the like.

The input/output device 3 is a generic term for devices to which a command is input from the driver or information is output to the driver. For example, the input/output device 3 includes various switches to which the driver inputs various commands by operating an operation member, a microphone to which the driver inputs a command by voice, a display that provides information to the driver via a display image, and a speaker that provides information to the driver by voice.

The position measurement unit (global navigation satellite system (GNSS) unit) 4 has a positioning sensor that receives a positioning signal transmitted from a positioning satellite. The positioning satellite is an artificial satellite such as a global positioning system (GPS) satellite or a quasi-zenith satellite. The position measurement unit 4 uses positioning information received by the positioning sensor to measure a current position (latitude, longitude, and altitude) of the subject vehicle.

The map database 5 is a device that stores general map information used for the navigation unit 6, and includes, for example, a hard disk or a semiconductor element. The map information includes road position information, information on a road shape (curvature or the like), and position information on intersections and branch points. The map information stored in the map database 5 is different from high-precision map information stored in the memory unit 12 of the controller 10.

The navigation unit 6 is a device that searches for a target route to a destination on a road which is entered by a driver and guides the driver along the target route. The input of the destination and the guidance along the target route are performed via the input/output device 3. The target route is calculated on the basis of a current position of the subject vehicle measured by the position measurement unit 4 and the map information stored in the map database 5. The current position of the subject vehicle can be measured using the detection values of the external sensor group 1, and the target route may be calculated on the basis of the current position and the high-precision map information stored in the memory unit 12.

The communication unit 7 communicates with various servers not illustrated via a network including wireless communication networks represented by the Internet, a mobile telephone network, and the like, and acquires the map information, travel history information, traffic information, and the like from the servers periodically or at an arbitrary timing. The travel history information of the subject vehicle may be transmitted to the server via the communication unit 7 in addition to the acquisition of the travel history information. The network includes not only a public wireless communication network but also a closed communication network provided for each of predetermined management areas, for example, a wireless LAN, Wi-Fi (registered trademark), Bluetooth (registered trademark), and the like. The acquired map information is output to the map database 5 and the memory unit 12, and the map information is updated.

The actuators AC are traveling actuators for controlling traveling of the subject vehicle. In a case where the traveling drive source is an engine, the actuators AC include a throttle actuator that adjusts an opening (throttle opening) of a throttle valve of the engine. In a case where the traveling drive source is a traveling motor, the actuators AC includes the traveling motor. The actuators AC include a brake actuator that operates the braking device in the subject vehicle and a steering actuator that drives the steering device.

The controller 10 includes an electronic control unit (ECU). More specifically, the controller 10 includes a computer including a processing unit 11 such as a CPU (microprocessor), the memory unit 12 such as a ROM and a RAM, and other peripheral circuits (not illustrated) such as an I/O interface. Although a plurality of ECUs having different functions such as an engine control ECU, a traveling motor control ECU, and a braking device ECU can be separately provided, in FIG. 1, the controller 10 is illustrated as a set of these ECUs for convenience.

The memory unit 12 stores highly precise detailed map information (referred to as high-precision map information). The high-precision map information includes information on the position of roads, road geometry (curvature and others), road gradients, positions of intersections and junctions, types and positions of road division lines such as white lines, number of lanes, lane width and position of each lane (center position of lanes and boundaries of lane positions), positions of landmarks (buildings, traffic lights, signs, and others) on maps, and road surface profiles such as road surface irregularities. In the embodiment, center lines, lane lines, outside lines, and the like are collectively referred to as road division lines. The high-precision map information stored in the memory unit 12 includes map information (referred to as external map information) that has been acquired from the outside of the subject vehicle via the communication unit 7, and a map (referred to as internal map information) created by the subject vehicle itself using detection values by the external sensor group 1 or detection values of the external sensor group 1 and the internal sensor group 2.

The external map information is, for example, information of a map that has been acquired via a cloud server (referred to as a cloud map), and the internal map information is, for example, information of a map (referred to as an environmental map) including three-dimensional point cloud data generated by mapping using a technology such as simultaneous localization and mapping (SLAM), for example. The external map information is shared among the subject vehicle and other vehicles, whereas the internal map information is map information that is exclusive to the subject vehicle (for example, map information that the subject vehicle owns by itself). For roads on which the subject vehicle has never traveled, newly constructed roads, and the like, environmental maps are created by the subject vehicle itself. Note that the internal map information may be provided to a server device or other vehicles via the communication unit 7. In addition to the above-described high-precision map information, the memory unit 12 also stores traveling trajectory information of the subject vehicle, various control programs, and thresholds for use in the programs.

The processing unit 11 includes a subject vehicle position recognition unit 13, an exterior environment recognition unit 14, an action plan generation unit 15, a driving control unit 16, and a map generation unit 17 as functional configurations.

The subject vehicle position recognition unit 13 recognizes (or estimates) the position (subject vehicle position) of the subject vehicle on a map, on the basis of the position information of the subject vehicle, obtained by the position measurement unit 4, and the map information of the map database 5. The subject vehicle position may be recognized (estimated) using the high-precision map information stored in the memory unit 12 and the peripheral information of the subject vehicle detected by the external sensor group 1, whereby the subject vehicle position can be recognized with high accuracy. The movement information (moving direction, moving distance) of the subject vehicle may be calculated on the basis of the detection values by the internal sensor group 2, and the subject vehicle position may be recognized accordingly. When the subject vehicle position can be measured by a sensor installed on a road or outside a road side, the subject vehicle position can be recognized by communicating with the sensor via the communication unit 7.

The exterior environment recognition unit 14 recognizes an external situation around the subject vehicle on the basis of signals from the external sensor group 1 such as the LiDAR, the radar, and the camera. For example, the position, speed, and acceleration of a surrounding vehicle (a forward vehicle or a rearward vehicle) traveling around the subject vehicle, the position of a surrounding vehicle stopped or parked around the subject vehicle, the positions and states of other objects, and the like are recognized. Other objects include signs, traffic lights, markings such as division lines and stop lines of roads, buildings, guardrails, utility poles, signboards, pedestrians, bicycles, and the like. The states of other objects include a color (red, green, yellow) of a traffic light, and the moving speed and direction of a pedestrian or a bicycle. A part of the stationary object among the other objects constitutes a landmark serving as an index of the position on the map, and the exterior environment recognition unit 14 also recognizes the position and type of the landmark.

The action plan generation unit 15 generates a driving path (target path) of the subject vehicle from a current point of time to a predetermined time ahead on the basis of, for example, the target route calculated by the navigation unit 6, the high-precision map information stored in the memory unit 12, the subject vehicle position recognized by the subject vehicle position recognition unit 13, and the external situation recognized by the exterior environment recognition unit 14. When there is a plurality of paths that are candidates for the target path on the target route, the action plan generation unit 15 selects, from among the plurality of paths, an optimal path that satisfies criteria such as compliance with laws and regulations, and efficient and safe traveling, and sets the selected path as the target path. Then, the action plan generation unit 15 generates an action plan corresponding to the generated target path. The action plan generation unit 15 generates various action plans corresponding to passing traveling for passing a preceding vehicle, lane change traveling for changing a travel lane, tracking traveling for tracking a preceding vehicle, lane keeping traveling for keeping a lane without departing from a travel lane, deceleration traveling or acceleration traveling, and the like. When the target path is generated, first, the action plan generation unit 15 determines a travel mode, and then generates the target path on the basis of the travel mode.

In the self-drive mode, the driving control unit 16 controls each of the actuators AC such that the subject vehicle travels along the target path generated by the action plan generation unit 15. More specifically, the driving control unit 16 calculates a requested drive force for obtaining target acceleration for each unit time calculated by the action plan generation unit 15 in consideration of traveling resistance determined according to a road gradient or the like in the self-drive mode. Then, for example, the actuators AC are feedback controlled so that an actual acceleration detected by the internal sensor group 2 becomes the target acceleration. More specifically, the actuators AC are controlled so that the subject vehicle travels at a target vehicle speed and the target acceleration. In the manual drive mode, the driving control unit 16 controls each of the actuators AC in accordance with a travel command (steering operation or the like) from the driver acquired by the internal sensor group 2.

The map generation unit 17 generates an environmental map in the surroundings of the road on which the subject vehicle has traveled, as internal map information, by using the detection values that have been detected by the external sensor group 1 while the subject vehicle is traveling in the manual drive mode. For example, an edge indicating an outline of an object or a characteristic region (blob) is extracted from a plurality of frames of camera images that have been acquired by the camera, on the basis of luminance and color information for each of pixels, and feature points are extracted with use of such edge or blob information. The feature points are, for example, intersections of edges, and correspond to corners of buildings, corners of road signs, or the like. The map generation unit 17 calculates a three-dimensional position of a feature point while estimating the position and posture of the camera so that identical feature points converge on a single point in a plurality of frames of camera images, in accordance with the algorithm of the SLAM technology. By performing this calculation processing for each of the plurality of feature points, an environmental map including the three-dimensional point cloud data is generated. Note that the environmental map may be generated by extracting feature points of objects around the subject vehicle using data acquired by a radar or LiDAR instead of a camera.

The subject vehicle position recognition unit 13 may perform subject vehicle position recognition processing on the basis of the environmental map generated by the map generation unit 17 and the feature points that have been extracted from the camera image. In addition, the subject vehicle position recognition unit 13 may perform the subject vehicle position recognition processing in parallel with the map creation processing by the map generation unit 17. The map creation processing and the position recognition (estimation) processing are simultaneously performed in accordance with the algorithm of the SLAM technology. The map generation unit 17 is capable of generating the environmental map not only when traveling in the manual drive mode but also when traveling in the self-drive mode. In a case where the environmental map has already been generated and stored in the memory unit 12, the map generation unit 17 may update the environmental map, on the basis of a newly extracted feature point (may be referred to as a new feature point) from a newly acquired camera image.

Incidentally, when recognizing (estimating) the position of the subject vehicle on the basis of the environmental map and the feature point extracted from the camera image, the subject vehicle position recognition unit 13 searches the environmental map (three-dimensional point cloud data) for the feature point corresponding to the feature point extracted from the camera image. Then, the subject vehicle position recognition unit 13 solves a perspective-n-point (PNP) problem on the basis of the correspondence relationship between the feature point extracted from the camera image and the searched feature point, thereby estimating the position and posture of the camera (subject vehicle). Note that the method of estimating the position and posture of the camera is not limited thereto, and the position and the posture of the camera may be estimated using another method such as Shape from Motion (SfM) for restoring the shape of the object from a plurality of camera images obtained from a moving camera. The subject vehicle position recognition unit 13 further improves the estimation accuracy by using a bundle adjustment method using camera images acquired from a plurality of viewpoints to adjust the position and posture of the subject vehicle obtained by solving the PNP problem or the like.

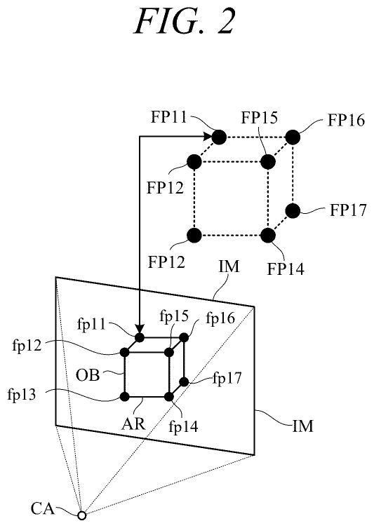

FIG. 2 is a diagram for explaining association of feature points. In FIG. 2, an image IM schematically represents a camera image of a camera CA. Black circles fp11 to fp17 in the camera image IM schematically represent feature points of a subject (object OB) extracted from the camera image. Black circles FP11 to FP17 schematically represent a part of point cloud data included in the environmental map, specifically, feature points constituting a point cloud corresponding to the object OB. A double-headed arrow in the drawing schematically indicates that the feature point fp11 extracted from the camera image is associated with the feature point FP11 among the feature points FP11 to FP17 on the environmental map. When the feature point in the camera image and the feature point on the environmental map are correctly associated with each other like the feature point fp11 in FIG. 2, the position and the posture of the subject vehicle can be accurately estimated using the PNP. In addition, by using the bundle adjustment method using camera images of a plurality of frames in combination with the PNP, it is possible to estimate the position and posture with higher accuracy.

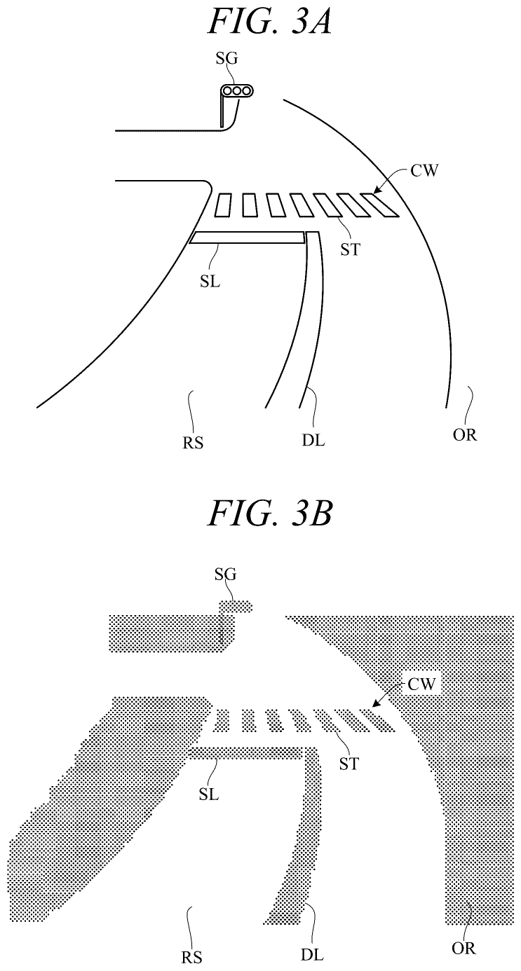

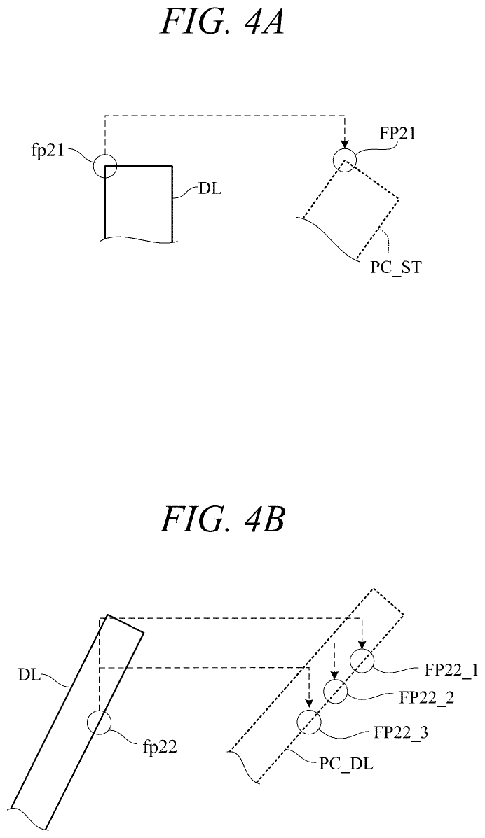

FIG. 3A is a diagram illustrating an example of a camera image acquired by an in-vehicle camera while the subject vehicle is traveling. FIG. 3A illustrates an example of a camera image of the front of the subject vehicle. FIG. 3B is a diagram illustrating an example of an environmental map corresponding to an imaging range of the camera image in FIG. 3A. As illustrated in FIG. 3A, various objects such as a traffic light SG, a crosswalk CW, a division line DL, and a stop line SL exist on a road on which the subject vehicle travels and around the road. Among these objects, there are objects having shapes partially similar to each other. Therefore, when a feature point is extracted from the camera image of FIG. 3A and the environmental map of FIG. 3B is searched for a feature point corresponding to the feature point, there is a possibility of occurrence of so-called erroneous matching in which a feature point different from a feature point to be originally searched for is acquired as a search result. FIGS. 4A and 4B are diagrams illustrating examples of erroneous matching. Since the corner of the division line and the corner of the crosswalk have similar shapes, there is a possibility that as in the example of FIG. 4A, a feature point fp21 of the division line DL in the camera image is erroneously associated with a feature point FP21 of a point cloud PC_ST (a point cloud corresponding to a line ST of the crosswalk CW) on the environmental map. In addition, there is a case where for a feature point of a portion, such as the edge of the division line, where the same shape is continuous, a plurality of candidates of a corresponding feature point are extracted from the environmental map. Even in such a case, there is a possibility that erroneous matching occurs. Feature points FP22_1 to FP22_3 in FIG. 4B schematically represent candidates of a feature point corresponding to a feature point fp22 of the edge of division line DL, the candidates being extracted from the environmental map. In the example of FIG. 4B, there is a possibility that the feature point fp22 is not associated with a feature point (for example, the feature point FP22_2) to be originally associated among a point cloud PC_DL (a point cloud corresponding to the division line DL) on the environmental map, but is erroneously associated with another feature point (for example, the feature point FP22_1 or feature point FP22_3). In order to suppress such erroneous matching, in the present embodiment, the position estimation apparatus 50 is configured as follows.

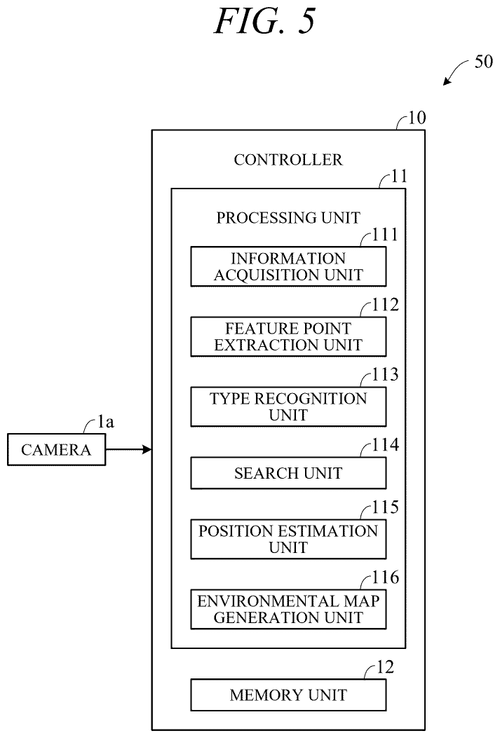

FIG. 5 is a block diagram illustrating the configuration of main parts of the position estimation apparatus 50 according to the present embodiment. The position estimation apparatus 50 constitutes a part of the vehicle control system 100 in FIG. 1. As illustrated in FIG. 5, the position estimation apparatus 50 includes the controller 10 and a camera 1a.

The camera 1a is a monocular camera including an imaging element (image sensor) such as a CCD or a CMOS, and constitutes a part of the external sensor group 1 in FIG. 1. The camera 1a detects a situation around the subject vehicle. The camera 1a is attached to, for example, a predetermined position in a front part of the subject vehicle, continuously captures images of a space ahead of the subject vehicle at a predetermined frame rate, and sequentially outputs frame image data (camera images) as detection information to the controller 10. Note that the camera 1a may be a stereo camera.

The controller 10 includes a processing unit 11 and a memory unit 12. The processing unit 11 includes, as functional configurations, an information acquisition unit 111, a feature point extraction unit 112, a type recognition unit 113, a search unit 114, a position estimation unit 115, and an environmental map generation unit 116. The memory unit 12 stores map information (environmental map) of roads on which the subject vehicle has traveled in the past. In addition, the memory unit 12 stores type information indicating the type (such as a division line, a stop line, a road surface, and a traffic light) of the corresponding object for each feature point included in the environmental map.

The environmental map generation unit 116 is included in the map generation unit 17 in FIG. 1, for example. The feature point extraction unit 112, the type recognition unit 113, the search unit 114, and the position estimation unit 115 are included in, for example, the subject vehicle position recognition unit 13 in FIG. 1.

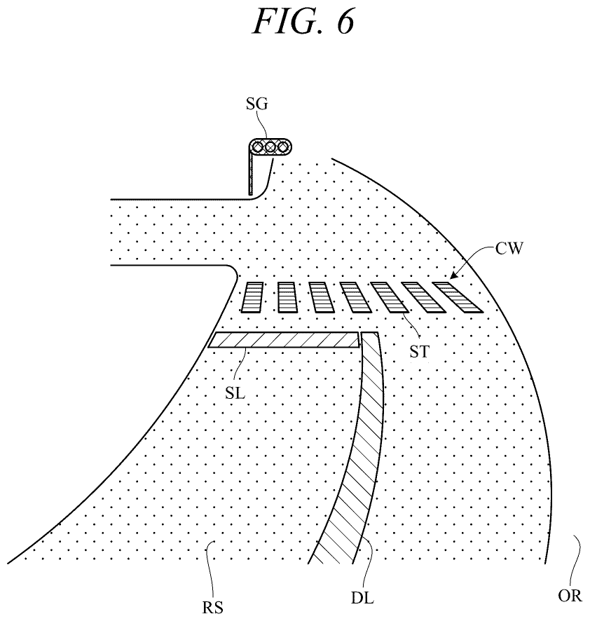

The information acquisition unit 111 acquires a camera image from the camera 1a. The feature point extraction unit 112 extracts a feature point from the camera image that has been acquired by the information acquisition unit 111 while the subject vehicle is traveling on a road. The type recognition unit 113 recognizes the type of the object corresponding to the feature point extracted by the feature point extraction unit 112 on the basis of the camera image of the camera 1a. Specifically, the type recognition unit 113 classifies the region of the camera image for each object type (such as a division line, a crosswalk, a road surface, and a traffic light) using a segmentation technology using machine learning or the like. Then, the type recognition unit 113 recognizes the type of the object corresponding to each feature point by determining to which region each feature point extracted by the feature point extraction unit 112 belongs. FIG. 6 is a diagram schematically illustrating the camera image (the camera image in FIG. 3A) divided into regions for each type of object. In FIG. 6, shading applied to each region indicates the type of the object corresponding to each region. Specifically, the region shaded by dots corresponds to a road surface, the region shaded by right-slanted lines corresponds to a division line, the region shaded by horizontal stripes corresponds to a crosswalk, the region shaded by left-slanted lines corresponds to a stop line, and the region shaded by diagonal grids corresponds to a traffic light.

The search unit 114 searches the environmental map for a feature point (hereinafter, referred to as a corresponding feature point) corresponding to a feature point (hereinafter, referred to as an extracted feature point) extracted by the feature point extraction unit 112. At this time, when the type of the extracted feature point recognized by the type recognition unit 113 is different from the type of the corresponding feature point indicated by the type information stored in the memory unit 12, the search unit 114 excludes the pair of the extracted feature point and the corresponding feature point from the search result. For example, as illustrated in FIG. 4A, when the type (division line) of the extracted feature point fp21 is different from the type (stop line) of the corresponding feature point FP21, the pair of the extracted feature point fp21 and the corresponding feature point FP21 is excluded from the search result.

The position estimation unit 115 estimates the position and posture of the camera 1a on the basis of the feature point (extracted feature point) extracted by the feature point extraction unit 112 and the corresponding feature point searched for by the search unit 114. Note that, for estimation of the position and posture of the camera 1a, the position estimation unit 115 does not use a pair of the corresponding feature point and the extracted feature point excluded from the search result by the search unit 114.

Here, processing of the position estimation unit 115 will be described. The position estimation unit 115 estimates the position and posture of the camera 1a by solving the PNP problem on the basis of a correspondence relationship between two-dimensional coordinates (position coordinates on the camera image) of the extracted feature point extracted by the feature point extraction unit 112 and three-dimensional coordinates (position coordinates on the environmental map) of the corresponding feature point searched for by the search unit 114. Solving the PNP problem is to calculate the position and posture of the camera 1a so as to minimize an error between the two-dimensional coordinates of the extracted feature point and two-dimensional coordinates obtained by projecting the three-dimensional coordinates of the corresponding feature point on the camera image. Note that the method of estimating the position and posture of the camera 1a is not limited thereto, and the position estimation unit 115 may estimate the position and posture of the camera 1a using another method such as SfM. An estimated value of the position and posture of the camera 1a obtained by solving the PNP problem is referred to as an initial estimated value. Note that since the camera 1a is attached to the subject vehicle as described above, the position and posture of the camera 1a are equivalent to the position and posture of the subject vehicle. Therefore, in the following, the position and posture of the camera 1a may be expressed as the position and posture of the subject vehicle, or simply as the self-position.

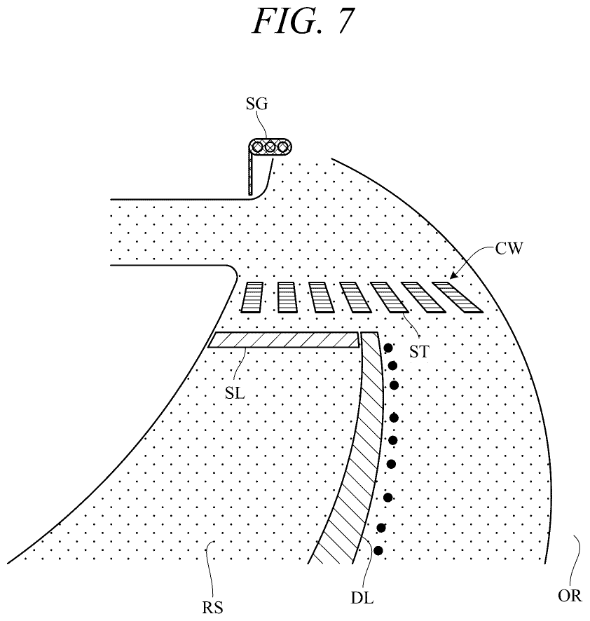

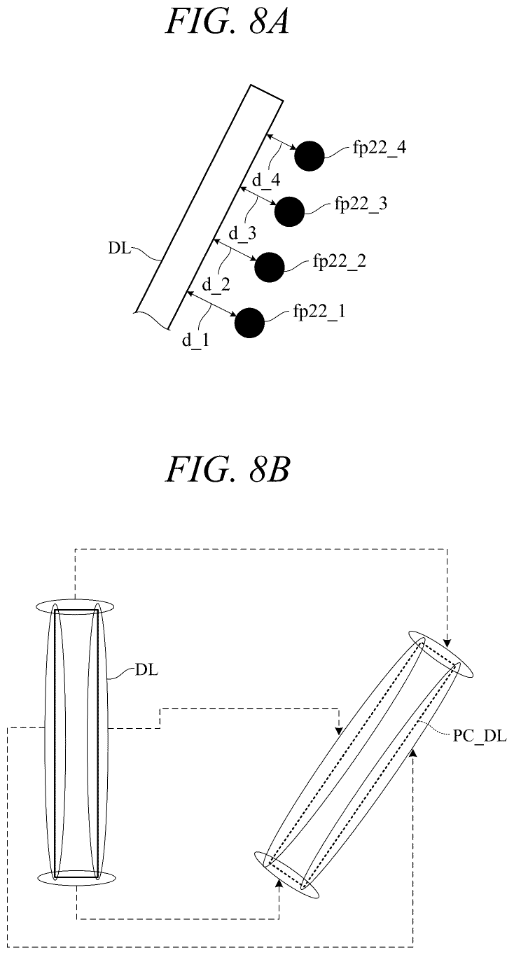

FIG. 7 is a diagram for explaining an estimation error of the self-position. FIG. 7 illustrates an example of a camera image on which feature points on the environmental map are projected. Black circles in FIG. 7 schematically represent feature points (specifically, feature points corresponding to the edge on the right side (right side in the drawing) in the advancing direction of the division line DL) on the environmental map projected on the camera image on the basis of the initial estimated value of the position and posture of the subject vehicle. When the feature points on the environmental map corresponding to the edge of the division line DL are projected on the camera image on the basis of the position and posture of the subject vehicle, the feature points are projected on or near the edge of the division line DL on the camera image. However, since the initial estimated value of the self-position obtained by solving the PNP problem includes an error, there is a possibility that the projection position deviates from the edge of the division line DL as illustrated in FIG. 7. Therefore, in order to reduce the self-position estimation error as described above, the position estimation unit 115 executes bundle adjustment using a plurality of camera images having different viewpoints. Note that the position estimation unit 115 performs the bundle adjustment by adding a predetermined constraint condition so as to further reduce the estimation error of the self-position. The predetermined constraint condition is defined such that, when the corresponding feature point included in the environmental map is projected on the camera image of the camera 1a on the basis of the self-position estimated by the position estimation unit 115, a vertical distance (hereinafter, referred to as a projection error) between the projected corresponding feature point and an object corresponding to the corresponding feature point is minimized on the camera image. FIGS. 8A and 8B are diagrams for explaining the constraint condition added to the bundle adjustment. In FIG. 8A, only four feature points fp22_1 to fp22_4 are illustrated as the feature points corresponding to the edge of the division line DL in order to simplify the drawing. In the case of FIG. 8A, the predetermined constraint condition is expressed by the following expression (i). d_n represents a vertical distance from the feature point fp22_n (n=1, 2, 3, . . . ) to the edge of the division line DL.

$$min \sum ( d\_n ) ⋀ 2 \qquad ( i )$$

When the bundle adjustment to which the constraint condition is added as described above is performed on each edge of the division line DL, as illustrated in FIG. 8B, the division line DL on the camera image and the point cloud PC_DL on the environmental map corresponding to the division line DL are matched as a plane. As a result, even in a case where point cloud data of a flat object, such as a division line, in which it is difficult to associate a feature point in a camera image with a feature point on an environmental map is used to estimate the self-position, the self-position can be accurately estimated without causing erroneous matching as illustrated in FIG. 4B.

When information (point cloud data) regarding the road on which the subject vehicle is traveling is not included in the environmental map stored in the memory unit 12, the environmental map generation unit 116 generates an environmental map corresponding to the road. Specifically, when the subject vehicle is traveling on a road (a road on which the subject vehicle has not traveled or a newly constructed road) for which an environmental map is not generated, the environmental map generation unit 116 generates point cloud data corresponding to the road on the basis of the feature points (extracted feature points) extracted by the feature point extraction unit 112, and adds the generated point cloud data to the environmental map. At this time, the environmental map generation unit 116 stores, in the memory unit 12, a recognition result (type information) of the type of the object for each feature point obtained by the type recognition unit 113 in association with each feature point. On the other hand, when the information regarding the road on which the subject vehicle is traveling is included in the environmental map, that is, when the subject vehicle is traveling on the road on which the environmental map is already generated, the environmental map generation unit 116 updates the environmental map stored in the memory unit 12 on the basis of the feature points (extracted feature points) extracted by the feature point extraction unit 112. In addition, the environmental map generation unit 116 updates the type information stored in the memory unit 12 on the basis of the recognition result of the type of the object for each feature point obtained by the type recognition unit 113.

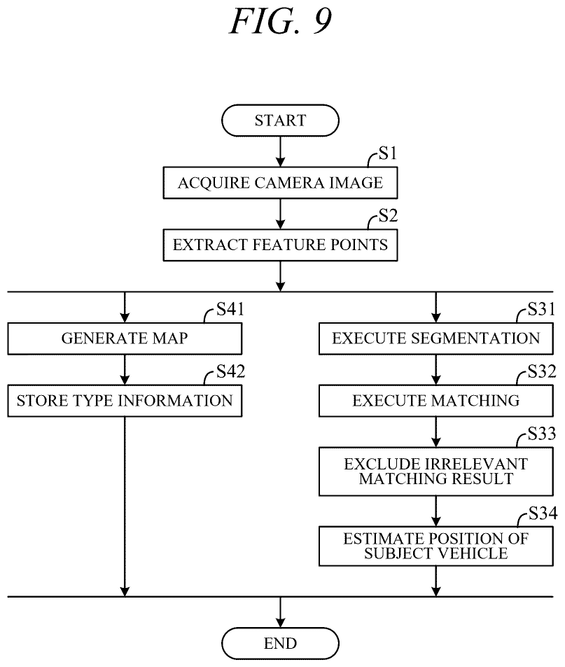

FIG. 9 is a flowchart illustrating an example of processing to be executed by the CPU of the controller 10 in FIG. 5, in accordance with a predetermined program. The processing illustrated in this flowchart is performed, for example, at a predetermined cycle while the subject vehicle is traveling in the self-drive mode.

First, in step S1, the controller 10 acquires a camera image from the camera 1a. In step S2, the controller 10 extracts feature points from the camera image acquired in step S1. In step S31, the controller 10 executes segmentation (region division) on the camera image acquired in step S1. Specifically, the camera image is divided into regions for each type of object. In step S32, the controller 10 matches each feature point (extracted feature point) extracted in step S2 with a feature point on the environmental map. Specifically, the environmental map stored in the memory unit 12 is searched for a feature point (corresponding feature point) corresponding to each extracted feature point. In step S33, the controller 10 determines a region to which each extracted feature point belongs, among regions obtained by dividing the camera image in step S31, and recognizes the type of the object associated with each extracted feature point on the basis of the determination result. Then, for each extracted feature point for which the corresponding feature point is found in the matching in step S32, that is, for each pair of the extracted feature point and the corresponding feature point, the controller 10 compares the type of the object associated with the extracted feature point with the type of the object associated with the corresponding feature point. As a result of the comparison, pairs having different types of objects are excluded from the matching result (search result).

In step S34, the controller 10 estimates the self-position on the basis of each extracted feature point and the corresponding feature point corresponding to each extracted feature point. More specifically, first, the controller 10 calculates the initial estimated value of the self-position, for example, by solving the PNP problem on the basis of the correspondence relationship between two-dimensional coordinates (position coordinates on the camera image) of the extracted feature point and three-dimensional coordinates (position coordinates on the environmental map) of the corresponding feature point. Next, the controller 10 executes bundle adjustment using a plurality of camera images having different viewpoints, with the constraint condition defined in the above expression (i) added. As a result, an error included in the initial estimated value is minimized, and a final estimated value of the self-position is calculated.

In addition, in parallel with the processing of steps S31 to S34, the controller 10 executes the processing of steps S41 to S42. In step S41, on the basis of the feature points (extracted feature points) extracted in step S2, the controller 10 generates an environmental map corresponding to the road on which the subject vehicle is traveling, and stores the environmental map in the memory unit 12. In step S42, the recognition result of the type of the object for each extracted feature point obtained in step S33 is stored as type information in the memory unit 12.

According to the above-described embodiment, the following effects can be achieved.

(1) The position estimation apparatus 50 estimates a position of a subject vehicle on the basis of a feature point (first feature point) of an object around the subject vehicle included in a camera image of the camera 1a that detects a situation around the subject vehicle and a feature point (second feature point) of the object included in environmental map. The position estimation apparatus 50 includes: the feature point extraction unit 112 that extracts the feature point of the object around the subject vehicle from the camera image of the camera 1a; the memory unit 12 that stores, for each feature point included in the environmental map, type information indicating a type of an object corresponding to the feature point together with the environmental map; the type recognition unit 113 as a recognition unit that recognizes the type of the object corresponding to the feature point (extracted feature point) extracted by the feature point extraction unit 112 on the basis of the camera image of the camera 1a; the search unit 114 that searches for a feature point (corresponding feature point) corresponding to the extracted feature point from the environmental map on the basis of the extracted feature point, the type of the object corresponding to the extracted feature point recognized by the type recognition unit 113, and the type information stored in the memory unit 12; and the position estimation unit 115 that estimates the position of the subject vehicle on the basis of the extracted feature point and the corresponding feature point searched for by the search unit 114. As a result, the traveling position of the subject vehicle can be accurately estimated.

(2) The position estimation unit 115 minimizes, by bundle adjustment, an error in the position of the subject vehicle estimated on the basis of the feature point (extracted feature point) extracted by the feature point extraction unit 112 and the feature point (corresponding feature point) searched for by the search unit 114. At this time, the position estimation unit 115 executes the bundle adjustment with a predetermined constraint condition added. The predetermined constraint condition is defined such that, when the corresponding feature point included in the environmental map is projected on the camera image of the camera 1a on the basis of the position of the subject vehicle estimated by the position estimation unit 115, a vertical distance between the corresponding feature point on the camera image and the object corresponding to the corresponding feature point is minimized. As a result, even in a case where point cloud data of a flat object, such as a division line, in which it is difficult to associate a feature point in a camera image with a feature point on an environmental map is used to estimate the traveling position of the subject vehicle, the traveling position of the subject vehicle can be accurately estimated without causing erroneous matching.

(3) The vehicle control system 100 further includes: the position estimation apparatus 50; the actuator AC for traveling; and the driving control unit 16 that controls the actuator AC on the basis of the position of the subject vehicle estimated by the position estimation unit 115. As a result, the subject vehicle can travel satisfactorily in the self-drive mode.

The above-described embodiment can be modified in various manners. Hereinafter, modifications will be described.

### (First Modification)

In the above-described embodiment, the information acquisition unit 111 acquires the detection data (camera image) of the camera 1a as an in-vehicle detection unit. However, the in-vehicle detection unit may be other than the camera, and may be a radar or a LiDAR, and the information acquisition unit may acquire detection data of the radar or LiDAR.

### (Second Modification)

In addition, in the above-described embodiment, the controller 10 executes self-position estimation processing (S31 to S34) at a predetermined cycle while the subject vehicle is traveling in the self-drive mode. However, the controller 10 may further function as a reliability determination unit that determines whether a reliability of the position of the subject vehicle estimated by the position estimation unit 115 is less than a predetermined degree. Note that the reliability determination unit determines that the reliability of the position of the subject vehicle estimated by the position estimation unit 115 is lower than the predetermined degree when a difference between the number of feature points corresponding to a predetermined region (for example, an imaging range of the camera 1a at the current point of time) ahead in the advancing direction of the subject vehicle and extracted by the feature point extraction unit 112 from the camera image at the current point of time and the number of feature points corresponding to the predetermined region among the feature points included in the environmental map stored in the memory unit 12 is equal to or larger than a predetermined threshold. In addition, the controller 10 may further function as a stop control unit that outputs a stop instruction to stop estimation of the position of the subject vehicle to the position estimation unit 115 while the subject vehicle is traveling on the road when the reliability determination unit determines that the reliability is lower than the predetermined degree, or when the number of times the reliability determination unit determines that the reliability is lower than the predetermined degree exceeds a predetermined number. In this manner, in a case where the position of the subject vehicle is continuously lost, the estimation of the position of the subject vehicle is interrupted, so that the processing load of the position estimation apparatus 50 can be reduced.

Note that, in this modification, the stop control unit may output the stop instruction to the position estimation unit 115 on the basis of the traveling state of the subject vehicle. In this case, the controller 10 also functions as a state acquisition unit that acquires vehicle state information indicating the state of the subject vehicle. The stop control unit determines whether the subject vehicle is capable of continuously traveling, on the basis of the vehicle state information acquired by the state acquisition unit. Upon determination that the subject vehicle is incapable of continuously traveling, the stop control unit outputs the stop instruction to the position estimation unit 115. The vehicle state information includes information indicating presence or absence of a puncture of a wheel (tire), acceleration information indicating the degree of shaking (shaking in the vertical direction or the lateral direction) of the vehicle body, and the like. For example, upon determination that the wheel is punctured, based on the vehicle state information, the stop control unit determines that the subject vehicle is incapable of continuously traveling. In addition, in a case where the acceleration in the vertical direction or the lateral direction of the vehicle body indicated by the vehicle state information (acceleration information) is equal to or larger than a predetermined value, the road surface condition is determined to be getting worse, and the subject vehicle is determined to be incapable of continuously traveling.

### (Third Modification)

Meanwhile, in a case where a time zone when the environmental map is generated or conditions (hereinafter, referred to as environmental conditions) such as brightness around the subject vehicle, weather (climate), and the like is different from the time zone or those when the camera image is acquired, the feature point (corresponding feature point) corresponding to the feature point (extracted feature point), which has been extracted from the camera image, is not present on the environmental map in some cases, or the corresponding point of the feature point on the environmental map is not present in the camera image in some cases. In this case, matching accuracy of feature points between the environmental map and the camera image decreases, and the position of the subject vehicle cannot be accurately recognized. In this regard, in order to cope with such a problem, the memory unit 12 may store a plurality of environmental maps respectively generated in different external environments in association with the environmental information indicating the external environment at the time of generating the environmental map. In this case, the environmental map generation unit 116 acquires information regarding weather, time, and surrounding brightness at the time of generating the environmental map. More specifically, the environmental map generation unit 116 acquires weather information of the vicinity of the traveling position of the subject vehicle from an external server (not illustrated) that provides weather information via the communication unit 7. In addition, the environmental map generation unit 116 detects (acquires) brightness around the subject vehicle on the basis of the camera image of the camera 1a, and acquires imaging time of the camera image. The environmental map generation unit 116 stores, in the memory unit 12, information indicating the weather, time, and brightness acquired at the time of generating the environmental map as environmental information together with the environmental map. Similarly, the search unit 114 acquires information regarding the external environment (weather, time, and surrounding brightness) at the current point of time. The search unit 114 reads the environmental map corresponding to the external environment at the current point of time from the memory unit 12 on the basis of the acquired information and the environmental information stored in the memory unit 12, and searches the read environmental map for the feature point (corresponding feature point) corresponding to the feature point (extracted feature point) extracted from the camera image by the feature point extraction unit 112.

Furthermore, in the above-described embodiment, the position estimation apparatus 50 is applied to a self-driving vehicle, but the position estimation apparatus 50 is also applicable to a vehicle other than the self-driving vehicle. For example, the position estimation apparatus 50 is also applicable to a manual driving vehicle including advanced driver-assistance systems (ADAS).

The above embodiment can be combined as desired with one or more of the above modifications. The modifications can also be combined with one another.

According to the present invention, the traveling position of the subject vehicle can be accurately estimated.

Above, while the present invention has been described with reference to the preferred embodiments thereof, it will be understood, by those skilled in the art, that various changes and modifications may be made thereto without departing from the scope of the appended claims.

What is claimed is:

1. A position estimation apparatus configured to estimate a position of a vehicle based on a first feature point of an object around the vehicle included in detection data of an in-vehicle detection unit detecting a situation around the vehicle and a second feature point of the object included in map information, the position estimation apparatus comprising
a microprocessor and a memory coupled to the microprocessor, wherein
the memory is configured to store type information indicating a type of the object corresponding to the second feature point together with the map information, and
the microprocessor is configured to perform:
extracting the first feature point from the detection data of the in-vehicle detection unit;
recognizing the type of the object corresponding to the first feature point, based on the detection data of the in-vehicle detection unit;
searching for the second feature point corresponding to the first feature point from the map information based on the first feature point, the type of the object corresponding to the first feature point, and the type information stored in the memory; and
estimating the position of the vehicle based on the first feature point and the second feature point.

2. The position estimation apparatus according to claim 1, wherein
the microprocessor is configured to perform
minimizing, by bundle adjustment, an error in the position of the vehicle estimated based on the first feature point and the second feature point.

3. The position estimation apparatus according to claim 2, wherein
the microprocessor is configured to perform
the estimating including executing the bundle adjustment with a predetermined constraint condition added, and
the predetermined constraint condition is defined such that, when the second feature point included in the map information is projected on an image indicated by the detection data of the in-vehicle detection unit based on the position of the vehicle, a vertical distance on the image between the second feature point and the object corresponding to the second feature point is minimized.

4. The position estimation apparatus according to claim 1, wherein
the memory stores each of a plurality of map information respectively generated in different external environments in association with environmental information indicating an external environment at a time of generating the map information, and
the microprocessor is configured to perform
the searching including reading the map information corresponding to the external environment at a time point of acquiring the detection data of the in-vehicle detection unit from the memory based on the environmental information, and searching the map information for the second feature point corresponding to the first feature point extracted from the detection data.

5. The position estimation apparatus according to claim 1, wherein
the microprocessor is configured to further perform:
determining whether a reliability of the position of the vehicle is less than a predetermined degree; and
stopping the estimating of the position of the vehicle when a number of times the reliability is determined to be lower than the predetermined degree exceeds a predetermined number while the vehicle is traveling on a road included in the map information.

6. The position estimation apparatus according to claim 1, wherein
the microprocessor is configured to further perform:
acquiring vehicle state of the vehicle; and
stop the estimating of the position of the vehicle based on the vehicle state.

7. The position estimation apparatus according to claim 6, wherein
the vehicle state includes at least one of information indicating a puncture of a wheel and acceleration information indicating the degree of shaking of the body of the vehicle, and
the microprocessor is configured to perform
the stopping including determining whether the vehicle is incapable of continuously traveling based on the vehicle state, and stopping the estimating of the position of the vehicle when the vehicle is determined to be incapable of continuously traveling.

8. The position estimation apparatus according to claim 1 further comprising
an actuator for traveling, and
the microprocessor is configured to further perform
controlling the actuator based on the position of the vehicle.
